(19) United States
(12) Patent Application Publication
(10) Pub. No.: US 2019/0385806 A1
(43) Pub. Date: Dec. 19, 2019

(54) POWER SWITCH

(71) Applicant: Siemens Aktiengesellschaft, Muenchen (DE)

(72) Inventors: Gerald PLANK, Fensterbach (DE); Michael STEHLE, Postbauer-Heng (DE)

(73) Assignee: Siemens Aktiengesellschaft, Muenchen (DE)

(21) Appl. No.: 16/480,084

(22) PCT Filed: Nov. 9, 2017
(86) PCT No.: PCT/EP2017/078683

§ 371 Date: Jul. 23, 2019

(30) Foreign Application Priority Data
Jan. 26, 2017 (DE) 10 2017 201 239.0

(51) Int. Cl. H01H 71/24; H01F 27/24

(52) U.S. Cl. CPC H01H 71/24; H01F 27/24

(57) ABSTRACT

A power switch is for interrupting an electrical circuit when current and/or current time span threshold values are exceeded. The power switch includes an energy converter, which on the primary side is connected to the electrical circuit, and on the secondary side provides an energy supply for at least one control unit of the power switch. The energy converter has a core having a remanence flux density (Br2) of less than 30% of the saturation flux density (Bs2) or a coercive field strength (Hc2) of less than 10 A/m.

### Priority Statement

This application is the national phase under 35 U.S.C. § 371 of PCT International Application No. PCT/EP2017/078683 which has an International filing date of Nov. 9, 2017, which designated the United States of America and which claims priority to German patent application number DE 102017201239.0 filed Jan. 26, 2017, the entire contents of which are hereby incorporated herein by reference.

### FIELD

Embodiments of the invention relate to a circuit breaker.

### BACKGROUND

Circuit breakers are protective devices which function in a similar manner to a fuse. Circuit breakers monitor the current flowing through them via a conductor and interrupt the electrical current or energy flow to an energy sink or a load, which is referred to as tripping, if protective parameters such as current limit values or current period limit values, that is to say if a current value is present for a certain period, are exceeded. The interruption is effected, for example, by way of contacts of the circuit breaker which are opened.

There are different types of circuit breakers, in particular for low-voltage circuits or networks, depending on the level of the electrical current provided in the electrical circuit. In the sense of the invention, circuit breaker is used to mean, in particular, switches which are used in low-voltage installations for currents of 63 to 6300 amperes. More specifically, closed circuit breakers are used for currents of 63 to 1600 amperes, in particular of 125 to 630 or 1200 amperes. Open circuit breakers are used, in particular, for currents of 630 to 6300 amperes, more specifically of 1200 to 6300 amperes.

Open circuit breakers are also referred to as air circuit breakers, ACB for short, and closed circuit breakers are referred to as molded case circuit breakers, MCCB for short.

Low voltage is used to mean, in particular, voltages up to 1000 volts AC or 1500 volts DC.

In the sense of embodiments of the invention, circuit breaker is used to mean, in particular, circuit breakers having a control unit such as an electronic trip unit, ETU for short. The control unit monitors the level of the electrical current measured by sensors such as Rogowski coils and additionally the voltage or/and other parameters of the electrical circuit in a similar manner and interrupts the electrical circuit. Electrical energy is needed to operate the control unit and is provided by an energy converter, for example a transformer. The latter is connected, on the primary side, to the electrical circuit to be protected and, on the secondary side, to the control unit.

In the event of an excessively “high” current flow, circuit breakers interrupt the circuit according to their protective parameters or response values. The protective parameters or response values are substantially the level of the current and the time after which the circuit is intended to be interrupted in the case of a persistently “high” current flow. In contrast to a fuse, these protective parameters or response values are adjustable in a circuit breaker, for example via the control unit such as an electronic trip unit.

The energy converters are used for the so-called energy self-supply of circuit breakers. They are based on the principle of magnetically coupled power transmission, as a result of which energy is provided for the control unit such as an electronic trip unit.

Energy converters such as current converters which operate in the linear range up to approximately 200% of the defined primary current are currently used in circuit breakers.

The currently used energy converters such as current converters are based on a wound core made of grain-oriented FeSi magnetic sheet steel (ferrosilicon). This material has a high permeability along the rolling direction, a high saturation magnetization of typically 1.9 T and a relatively low magnetic power loss of typically approximately 1-2 W/kg at 50 Hz. These parameters enable a very low magnetic cross section and therefore a very compact design of the current converter in order to achieve the minimum required secondary output power.

EP 0 563 606 A2 discloses a current converter for pulse-current-sensitive residual current circuit breakers. Furthermore, EP 2 416 329 A1 discloses a magnet core for low-frequency applications and a method for producing it. DE 10 2013 211 811 A1 furthermore discloses a converter unit. Finally, EP 1 154 539 A1 discloses a residual current circuit breaker with a summation current converter.

### SUMMARY

At least one embodiment of the present invention is directed to improving a circuit breaker.

In particular, at least one embodiment of the application is directed to a A circuit breaker for interrupting an electrical circuit upon at least one of current and current period limit values being exceeded, comprising:
an energy converter, connected on a primary side to the electrical circuit and, connected on a secondary side, to provide an energy supply for at least one control unit of the circuit breaker, the energy converter including a core, a remanence flux density of the core being less than 30% of a saturation flux density of the core, wherein the core includes a ferromagnetic nanocrystalline material.

### BRIEF DESCRIPTION OF THE DRAWINGS

The described properties, features and advantages of this invention and the manner in which they are achieved become more clearly and distinctly comprehensible in connection with the following description of the exemplary embodiments which are explained in more detail in connection with the drawings.

In this case, in the drawings:

FIG. 1 shows a first graph having a first hysteresis curve,

FIG. 2 shows a second graph having a second hysteresis curve,

FIG. 3 shows a cross section through a converter unit having a particle layer above an upper secondary winding,

FIG. 4 shows the converter unit according to FIG. 3 with a film above the upper secondary winding,

FIG. 5 shows the converter unit according to FIG. 4 with a perforated disk element resting on the film.

### DETAILED DESCRIPTION OF THE EXAMPLE EMBODIMENTS

In particular, at least one embodiment of the application is directed to a circuit breaker having an energy converter including a core, the remanence flux density (Br2) of which is less than 30%, in particular less than 20%, of the saturation flux density (Bs2).

Furthermore, its coercive field strength (Hc2) may be less than 10 A/m, in particular less than 5 A/m.

This core is made of a ferromagnetic nanocrystalline material. Nanocrystalline material is used to mean a material having a particle size of 1 to 100 nm, in particular a material having a particle size of 5 to 20 nm. Grain sizes of 10 nm are particularly suitable, in particular.

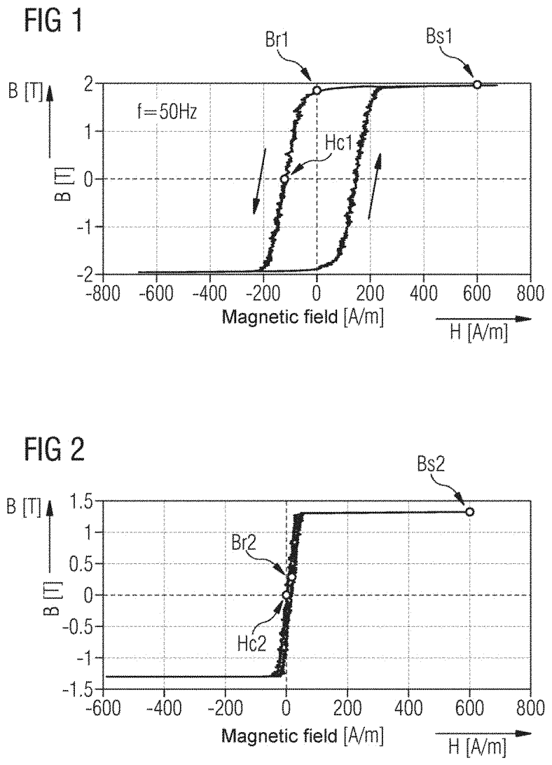

This has the advantage that the typical Z shape of the magnetic hysteresis loop in the known grain-oriented FeSi magnetic sheet steel or electrical steel, see FIG. 1, is avoided. In the case of the conventional FeSi material (ferrosilicon), the energy converters exhibit a remnant magnetic flux without an external magnetic field. This so-called remanence effect is particularly great if the magnetic core enters the state of magnetic saturation as a result of the load of a control unit such as an electronic trip unit (ETU). This state is reached if a very high secondary current is caused by a very high primary current, the secondary power increases and the apparent power of the current converter is consequently exceeded.

In the state of magnetic saturation, the magnetic flux in the core can no longer change over time. This results in no secondary voltage being induced and in the secondary current collapsing. The described behavior is often observed in the event of a short circuit in the electrical circuit, as a result of which the primary-side current in the energy converter is very high.

The state of high remnant magnetization is canceled by the subsequent polarity change in the primary current. However, the task of the control unit such as the electronic trip unit in the circuit breaker is to detect the short-circuit situation and to trip the switch in order to prevent the further primary-side current flow through an open switch. This is then possibly carried out only with a delay.

If the switch is switched on again at a later time, the polarity of the primary current flowing again cannot be predicted. It may therefore happen that the polarity is the same as the last polarity before tripping and the electronic operational readiness is thus delayed by a polarity change. This situation is particularly critical in single-phase systems since the delay may last for up to half a period.

Remnant magnetization is an intrinsic property of conventional magnetic sheet steel with high permeability. This occurs both in grain-oriented and non-grain-oriented sheet steel. Through the selection of raw material and special technical treatments, it is possible to attenuate the strong remnant magnetization without an external magnetic field and to convert the magnetic hysteresis into an R type. However, the permeability of the material typically falls at the same time. A further possibility arises by inserting an air gap into the magnetic core. The parallel orientation of the magnetic domains in the remnant state is broken at this air gap. Physics require the potential energy in the quasi-static system to be minimized and therefore prohibit an external magnetic field in the air gap for highly permeable magnetic sheet steel. Therefore, closing domains with a vertical magnetization direction form along the edge to the air gap and in turn continue in the core through domains with an opposite magnetization direction, that is to say the parallel orientation of the magnetic polarization in one direction is prevented. The strong reduction in the permeability, which is practically determined only by the ratio of the air gap width to the effective magnetic core length, is also disadvantageous here.

However, a high permeability is needed to ensure the electronic trip readiness for small primary currents in the case of a small available installation space.

This is achieved, according to an embodiment of the invention, by way of an energy converter having the technical values mentioned, which energy converter consists of (modern) nanocrystalline material, for example, avoids the disadvantages mentioned and has the advantages mentioned.

Advantageous configurations are stated in the claims.

In one advantageous configuration of an embodiment of the invention, the energy converter has a core, the saturation flux density of which is at least 1 T, in particular at least 1.2 T. This has the particular advantage that a high magnetic flux is achieved for a low magnetic field strength, thus making it possible to achieve a small design for the energy converter.

In one advantageous configuration of an embodiment of the invention, the core of the energy converter is a nanocrystalline tape-wound core. In particular, tapes having a thickness of between 1 and 100 μm, more specifically having a thickness of 10 to 35 μm, in particular thicknesses of 20 to 25 μm, are highly suitable.

This has the particular advantage that cores of virtually any desired size can be produced by placing the tapes on top of one another or winding the tapes.

In one advantageous configuration of an embodiment of the invention, the core has transverse magnetic anisotropy.

Transverse magnetic anisotropy is used to mean, in particular, magnetic cross-field anisotropy.

This has the particular advantage that cores of this type, in particular made of nanocrystalline tape, have virtually no remnant magnetic flux. The magnetic hysteresis has an F shape (flat), also see FIG. 2. Nevertheless, cores of this type have a permeability comparable to conventional magnetic sheet steel, in which case the magnetic power loss in the nanocrystalline toroidal tape-wound core is additionally very much lower.

In one advantageous configuration of an embodiment of the invention, the circuit has at least one conductor which is guided through the circuit breaker and the current of which is at least partially the primary current of the energy converter.

This has the particular advantage that the complete current in the circuit does not form the primary current of the energy converter or current converter, but rather only a defined partial current. This enables a smaller design for the energy converter in the circuit breaker.

In one advantageous configuration of an embodiment of the invention, the energy converter is in the form of a ring or a toroidal core.

This has the particular advantage that it is possible to achieve a particularly compact design for an energy converter since angular shapes (M section, E-I section, . . . ) have a greater space requirement for the same power.

In one advantageous configuration of an embodiment of the invention, the energy converter is arranged in a converter unit, also having a current measuring device, for example a Rogowski coil.

This has the particular advantage that it is possible to form a compact combination converter module for the self-supply and current sensor system of a circuit breaker.

All configurations, both in dependent form referring back to an independent claim, and referring back only to individual features or combinations of features of patent claims, improve a circuit breaker, in particular the energy converter.

FIG. 1 shows a graph having a first magnetic hysteresis curve, for example for a wound FeSi toroidal tape-wound core. The magnetic field strength H in A/m (amperes per meter) is plotted on the horizontal X axis of the graph. The magnetic flux B in T (Tesla) is plotted on the vertical Y axis. A typical hysteresis, as is known to a person skilled in the art, is plotted. This type of curve is also referred to as a so-called Z shape. Important properties of the material depicted in the curve are the magnetic saturation flux density Bs1, the remanence flux density Br1, often also referred to only as remanence, and the coercive field strength Hc1.

If a ferromagnetic core is wound with an electrical primary winding or primary coil and a current is sent through the electrical conductor of the primary winding, the resulting magnetic field H [A/m] generates a magnetic flux B [T] in the core. The winding may also involve only one turn or a conductor can be guided through a (toroidal) core, so-called half the number of turns, in order to generate a magnetic flux in the core.

This magnetic flux increases with increasing magnetic field or increasing magnetic field strength. However, not arbitrarily, but rather only to the so-called saturation flux density Bs1. If the latter has been reached, an increase in the magnetic field strength H does not increase the magnetic flux B in the core. The flux remains constant at the saturation flux density Bs1. This is indicated in FIG. 1 with the rising arrow illustrated beside the right-hand part of the characteristic curve.

If the magnetic field H is only reduced to the value of zero again (H=0 A/m), a magnetic flux Br1 nevertheless remains in the core. This is referred to as the remanence flux density Br1.

The magnetic flux in the core can be changed to the value of zero again (B=0 T) only with a magnetic field directed in the opposite direction (negative magnetic field strength in FIG. 1). The magnetic field strength Hc1 required for this purpose is referred to as the coercive field strength Hc1. This is indicated in FIG. 1 with the falling arrow illustrated beside the left-hand part of the characteristic curve.

One aim of an embodiment of the invention is to reduce the state of delayed operational readiness of a circuit breaker as a result of remnant magnetic flux Br1 in the core of the energy converter, with simultaneously high permeability as far as possible and high magnetic saturation or saturation polarization, in order to achieve the smallest possible size for the energy converter.

This is intended to be achieved, according to the invention, with a nanocrystalline core as the energy converter.

Nanocrystalline tapes made of ferromagnetic materials are produced by the rapid solidification of the melt on a rotating disk or roller to form an amorphous tape and defined thermal and magnetic post-treatment of the wound amorphous tape.

The thermal post-treatment of the tape (annealing process) results in recrystallization in the tape. Nanocrystals with ferromagnetic properties are formed. If this recrystallization process is carried out under an external magnetic field, the easy axis of the magnetization is oriented with the magnetic field direction during the formation of the nanocrystals. After the wound nanocrystalline tape has been cooled, a ferromagnetic core with very high permeability and very narrow magnetic hysteresis, that is to say very low magnetic power loss, is obtained. Magnetic cores and current converters of this type can be operated into the MHz range.

The hysteresis curve of such a core is illustrated in FIG. 2. FIG. 2 shows a graph according to FIG. 1 with the difference that a magnetic hysteresis curve for e.g. a nanocrystalline toroidal tape-wound core, in particular with transverse anisotropy, is illustrated. This is distinguished by a much lower residual flux density Br2 and a much lower coercive field strength Hc2.

The magnetic saturation flux density Bs2 is approximately as large as that shown in FIG. 1.

The curve has a so-called F shape (F for flat).

The relatively high saturation polarization of 1.2 T (at least 1 T) and the very high permeability are particularly advantageous for use as energy converters for circuit breakers for supplying energy to a control unit, that is to say as the magnetically coupled energy self-supply of the electronic trip unit in the circuit breaker. The low magnetic core losses are advantageous, in particular in power supply systems which have substantial current harmonics, as are nowadays increasingly exposed to the circuit breakers, since grain-oriented magnetic sheet steel has very high magnetic power losses at high frequencies.

As described above, the magnetic orientation in the wound tape-wound core is influenced by the magnetic field during the recrystallization. If the magnetic field is oriented in an annular manner around the center point of the toroidal core, longitudinal magnetic anisotropy is produced in the nanocrystalline tape. Toroidal cores of this type have an extremely high permeability but also a highly pronounced Z shape of the magnetic hysteresis. Therefore, such cores exhibit a pronounced remnant magnetic flux.

If, in contrast, the external magnetic field is oriented in a homogeneously parallel manner with respect to the toroidal core axis, transverse magnetic anisotropy is produced during the recrystallization. Toroidal cores of this type made of nanocrystalline tape have virtually no remnant magnetic flux since the magnetic polarization of the nanocrystals is oriented perpendicular to the ring circumference without an external field. The magnetic hysteresis has an F shape, as illustrated in FIG. 2. Nevertheless, cores of this type have a permeability comparable to conventional magnetic sheet steel, but the magnetic power loss in the nanocrystalline toroidal tape-wound core is additionally very much lower.

Nanocrystalline toroidal cores of this type can replace the wound toroidal cores made of grain-oriented magnetic sheet steel in the case of a comparable magnetic core cross section, which is advantageous, in particular, for circuit breakers, in particular for compact or open circuit breakers.

At least one embodiment of the invention makes it possible to implement a circuit breaker with a comparatively small energy converter which can also be implemented in networks with harmonics and in the case of high primary currents which exceed the defined currents, in which case there is a reliable energy supply for a control unit.

The following advantages can be achieved with a toroidal core made of nanocrystalline tape:

Very high permeability;

High magnetic saturation polarization;

=>considerably smaller installation space than in the case of toroidal cores made of ferrite material with the same apparent power;

=>suitability for typical network frequencies.

Similar size to cores made of magnetic sheet steel with the same apparent power;

=>easy replacement in existing designs.

Very narrow magnetic hysteresis, that is to say low magnetic power loss;

=>suitability for high frequencies;

=>suitability for networks with substantial current harmonics.

Furthermore, the following advantages result from the magnetic anisotropy which can be set during the recrystallization process:

Very low remnant magnetic flux as a result of transverse magnetic anisotropy;

=>no remanence effect;

=>undelayed tripping readiness of a control unit, for example ETU, in the circuit breaker irrespective of the “prior history” when previously switching off/tripping the circuit breaker.

The core material may contain, in particular, the elements Fe, Si, B, Nb or/and Cu.

A core according to an embodiment of the invention is intended to have, in particular, a remanence flux density Br which is less than 30%, in particular less than 20%, of the saturation flux density Bs. The coercive field strength Hc is intended to be less than 10 A/m, in particular less than 5 m/A.

If the core is in the form of a toroidal core, it may have both an inhomogeneously distributed secondary winding, that is to say a secondary winding concentrated on individual core sections or portions of the core, and a homogeneously distributed secondary winding. The primary winding may also only be in the form of a conductor which is guided through the toroidal core.

The toroidal core may ideally be closed and may not have an air gap.

The toroidal core may be annular, circular, oval, square, rectangular etc.

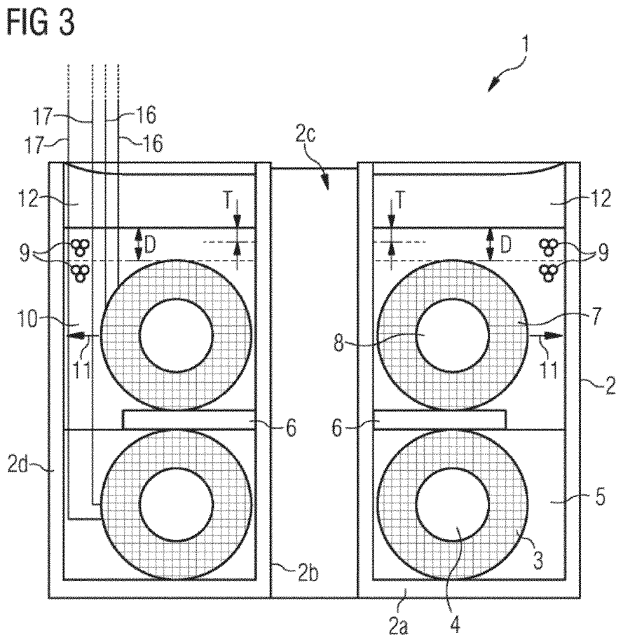

The energy converter according to an embodiment of the invention may be advantageously part of a converter unit, as illustrated in FIGS. 3 to 5.

FIG. 3 shows a schematic cross section through a converter unit 1 (combination current converter) for a circuit breaker (not shown) which is supplied with electrical energy by the converter unit 1 and is supplied with a signal for current measurement.

The converter unit 1 has a housing 2 which has the shape of a pot and is composed of an electrically insulating plastic. A hollow (passage) cylinder 2b (generally a passage channel 2c) is formed on the housing base 2a, through which cylinder a current conductor (not shown) runs as the primary conductor (primary winding) of the converter unit 1. The plastic has, by way of example, an insulating capacity of approximately 20-30 kV/mm here.

A (first) secondary winding 3 lies on the housing base 2a and is arranged concentrically in relation to the hollow cylinder 2b and is wound onto a non-magnetic toroidal core 4 (Rogowski converter for measuring current). The secondary winding 3 is at least predominantly embedded in an electrically insulating solid plastic compound 5. It goes without saying that the secondary winding 3 may also be a simple toroidal coil that is wound around the toroidal core 4.

A flat spacer element 6 in the form of a perforated disk rests directly on top of the secondary winding 3 by way of its lower flat side, so that the secondary winding 3 is at least partially covered in a radial manner as seen from above. There is no plastic compound 5 between the secondary winding 3 and the spacer element 6. In FIG. 1, the secondary winding 3 is completely covered in a radial manner as seen from above.

A further (second) secondary winding 7, which is wound onto a core according to an embodiment of the invention, in the example a magnetic toroidal core 8, for example, according to an embodiment of the invention, made of nanocrystalline material (e.g. ferromagnetic core converter for supplying energy), lies on the upper side of the spacer element 6. The spacer element 6 clearly defines the distance between the two secondary windings 3, 7. In this case, the magnetic toroidal core 8 is composed of soft magnetic material, such as nanocrystalline material according to an embodiment of the invention or material with the technical values according to an embodiment of the invention. It goes without saying that the winding 7 may also be a simple toroidal coil that is wound around the toroidal core 8.

The secondary winding 7 is completely embedded in electrically insulating loose particles 9 above the spacer element 6. In FIG. 1, the winding 7 is also completely covered by particles 9 in the direction of the top; the cover or the particle layer 10 has a thickness D in this case. In principle, an embedding arrangement in the radial direction 11 is already sufficient. The particles 9 that bear against one another are only schematically illustrated (at the top right) in FIG. 1. In other words, the particles 9 here fill the region next to and the region (with the thickness D) above the secondary winding 7.

The particles 9 are glass balls with a suitable diameter distribution (for example in the form of a Gaussian distribution in this case). As an alternative, however, said particles may also be ceramic powders or ceramic granules, in particular aluminum oxide (Al₂O₃) with an average particle size of 300 μm. Cured resin can also be pulverized, in principle.

In this case, the thickness D of the particle layer 10 amounts to several average particle diameters.

The region directly adjoining the particle layer 10 is encapsulated with an encapsulant 12. In this case, the encapsulant 12 bears firmly (intimately) against the inside of the housing wall 2d and at least also against the particles 9 that lie at the top in the direction of the housing opening.

However, starting from the top side of the particle layer 10, the particles 9 in FIG. 3 are even embedded in the encapsulant 12 down to a depth T of several average particle diameters, wherein the depth T is less than the thickness D of the particle layer 10. The encapsulant 12 thus bears against the particles 9 (all the way around) virtually down to a depth T, not only in each case against the top side of the particles 9 that lie at the top (at the very top) in the direction of the housing opening.

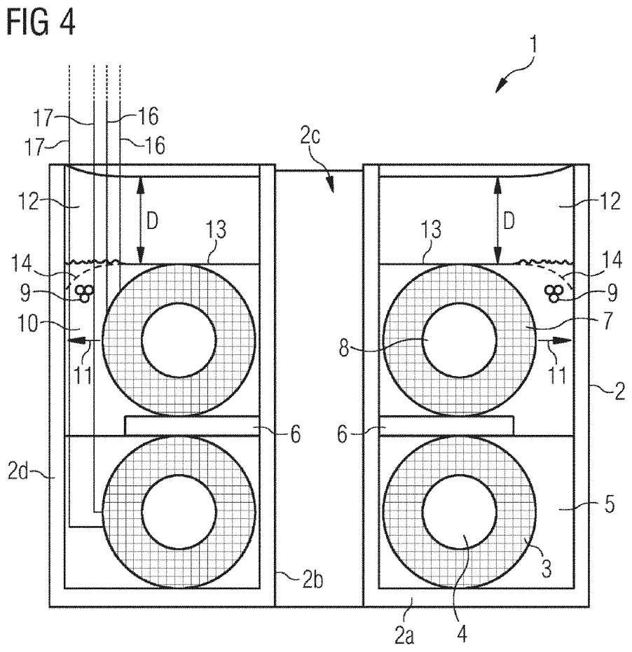

FIG. 4 shows an alternative converter unit 1 in which the top side of the second secondary winding 7 is covered by a thin film 13 instead of with a particle layer 10. The particles 9 that lie at the top in the direction of the housing opening and are further to the outside, as seen in the radial direction, and are therefore not covered by the film 13 are approximately in a plane with the film 13 in FIG. 4. The encapsulant 12 now bears firmly (intimately) against the top side of the film 13 and at least against the outer upper particles 9 since the film 13 does not reach the inside of the housing wall 2d.

The particles 9 in a plane with the film 13 can likewise be embedded in the encapsulant 12 over several average particle diameters, but without the encapsulant 12 reaching the second secondary winding 7.

In FIG. 4, the particles 9 are embedded in the encapsulant 12 over several average particle diameters. The embedding limit is schematically indicated by the dashed line 14.

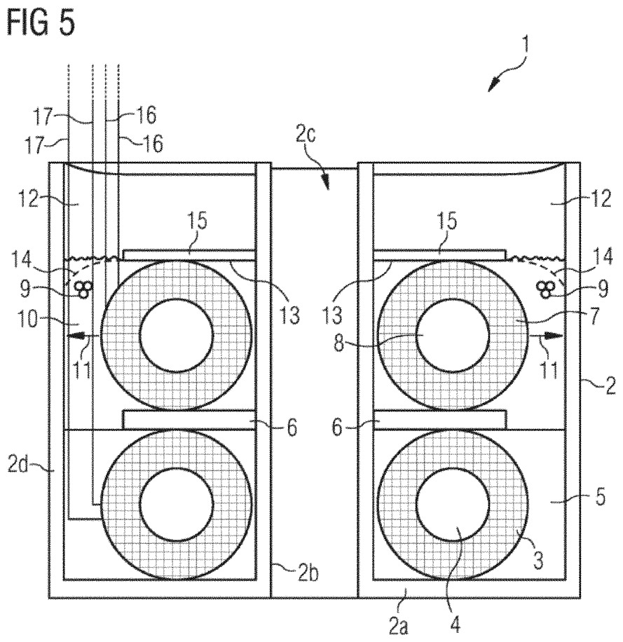

FIG. 5 shows a flat perforated disk element 15 which corresponds to the spacer element 6 and rests on the film 13 and at least partially covers the secondary winding 7 in a radial manner. This perforated disk element 15 holds down the secondary winding 7 during filling with the glass balls, that is to say substantially prevents the secondary winding 7 from floating. Alternatively, the film 13 may also rest on the spacer element 6.

The connection wires 16, 17 of the secondary windings 7, 3 are guided through the encapsulant 12.

The method for producing the converter unit 1 according to FIG. 3 (and accordingly FIGS. 4 and 5) comprises the following steps:
the secondary winding 3 is inserted into the housing 4,
the spacer element 6 is then pushed onto the secondary winding 3,
the plastic compound 5 is then filled in, wherein the top side of the spacer element 6 remains free of plastic compound 5,
the secondary winding 7 is then inserted into the housing 4, with the result that it comes to rest on the top side of the spacer element 6,
the particles 9 are then filled in, with the result that the secondary winding 7 is surrounded by the particles 9 in a radial manner and above and is embedded in said particles, and
the housing 4 which is open at the top is then encapsulated with the encapsulant 12, the flow properties of which ensure that the encapsulant 12 enters the particle layer 10 only to a depth T of several average particle diameters, in which case the encapsulation is carried out by way of a vacuum encapsulation system, in order to avoid air inclusions.

The converter unit which is provided for a circuit breaker and has the energy converter according to an embodiment of the invention is characterized, in particular:
in that the particles (9) cover the top side of the second secondary winding (7) with a particle layer (10), the thickness (D) of which amounts to several average particle diameters;
in that, starting from the top side of the particle layer (10), the particles (9) are embedded in the encapsulant (12) to a depth (T) of several average particle diameters, wherein the depth (T) is less than the thickness (D) of the particle layer (10);
in that the top side of the second secondary winding (7) is covered by a film (13) and the encapsulant (12) bears a) against the top side of the film (13) and b) against the particles (9) which are to the side of the film (13) and are at the top in the direction of the housing opening and are in a plane with the film (13);
in that the particles (9) which are to the side of the film (13) and are at the top in the direction of the housing opening and are in a plane with the film (13) are embedded in the encapsulant (12);
in that the embedding does not extend to the second secondary winding (7);
in that the particles (9) are spherical;
in that the particles (9) are in the form of glass balls;
in that a second flat perforated disk element (15) bears against the film (13) by way of a flat side and at least partially covers the film.

Although the invention has been described and illustrated more specifically in detail by way of the exemplary embodiment, the invention is not restricted by the disclosed examples and other variations can be derived herefrom by a person skilled in the art without departing from the scope of protection of the invention.

1. A circuit breaker for interrupting an electrical circuit upon at least one of current and current period limit values being exceeded, having comprising:
an energy converter, connected on a primary side to the electrical circuit and, connected on a secondary side, to provide an energy supply for at least one control unit of the circuit breaker, the energy converter including
a core, a remanence flux density of the core being less than 30% of a saturation flux density of the core, wherein the core includes a ferromagnetic nanocrystalline material.

2. The circuit breaker of claim 1, wherein the energy converter the saturation flux density of the core is at least 1 T.

3. The circuit breaker of claim 1. wherein the remanence flux density of the core is less than 20% of the saturation flux density.

4. The circuit breaker of claim 1, wherein coercive field strength of the core is less than 5 A/m.

5. The circuit breaker of claim 1, wherein the core of the energy converter is a nanocrystalline tape-wound core.

6. The circuit breaker of claim 1, the energy converter is in a form of a ring or a toroidal core.

7. The circuit breaker of claim 1, wherein the energy converter is provided as a converter unit including
an electrically insulating pot-shaped housing which includes, at a bottom, a housing base and a hollow cylinder arranged on the housing base and extending upward into an interior of the housing,
a non-magnetic toroidal core, including a first secondary winding resting on the housing base in a concentric manner with respect to the hollow cylinder and embedded in a solid compound,
the energy converter being in a form of a ring and including a second secondary winding arranged above the non-magnetic toroidal core in a concentric manner with respect to the hollow cylinder, and
an electrically insulating solidified encapsulant, usable to close an opening of the housing, the encapsulant (12), permanently connected to an inside of a housing wall of the housing, resting against the housing wall,
wherein a first flat spacer element is arranged between the first secondary winding and the second secondary winding,
wherein one flat side of a spacer element rests directly against the first secondary winding and another flat side rests directly against the second secondary winding,
wherein electrically insulating particles fill the space between the second secondary winding and the housing wall, in a radial direction, at least to a top side of the second secondary winding, and
wherein the encapsulant extends at least to particles at a top with respect to the housing opening.

8.-11. (canceled).

12. The circuit breaker of claim 1, wherein the energy converter the saturation flux density of the core is at least 1.2 T.

13. The circuit breaker of claim 2, wherein the remanence flux density of the core is less than 20% of the saturation flux density.

14. The circuit breaker of claim 2, wherein coercive field strength of the core is less than 5 A/m.

15. The circuit breaker of claim 3, wherein coercive field strength of the core is less than 5 A/m.
